(19) United States
(12) Patent Application Publication
(10) Pub. No.: US 2002/0197487 A1
(43) Pub. Date: Dec. 26, 2002

(54) Composite sheet used to protect displays

(76) Inventors: Peter Bier, Krefeld (DE); Andreas Elschner, Mulheim/Ruhr (DE); Klaus Zander, Muhlheim/Ruhr (DE); Joachim Genz, Krefeld (DE)

Correspondence Address: BAYER CORPORATION, PATENT DEPARTMENT, 100 BAYER ROAD, PITTSBURGH, PA, 15205, US

(21) Appl. No.: 10/181,285

(22) PCT Filed: Jan. 5, 2001
(86) PCT No.: PCT/EP01/00089

(30) Foreign Application Priority Data
Jan. 18, 2000 (DE) 100 01 795.9

(51) Int. Cl. B32B 17/06

(52) U.S. Cl. 428/426; 428/469; 428/701

(57) ABSTRACT

The invention relates to a composite sheet which is used to protect displays, especially plasma displays The composite sheet is essentially comprised of three sheets. The inner sheet (1) is made of a thermoplastic synthetic material and the outer sheets (2,3) are made of glass. The individual sheets (1,2,3) are firmly joined to each other by means of a thermoplastic polyurethane film (4). The glass sheet (3) facing the display is provided with electric screening. The inventive sheet, when detached from the display, can be used in a plurality of ways owing to the construction thereof. It is light, shatterproof and offers a wide range of design opportunities.

The invention relates to a composite pane for use as protection of displays, in particular of plasma displays.

With increasing development of data processing, displays for the indication of data are also finding ever wider application. Flat screens are becoming increasingly popular in this connection. The plasma displays that are used for this purpose are employed in many areas of information technology and communications technology, for example in conjunction with monitors for use with personal computers, television sets, telephone terminal equipment, advertising spaces for the display of variable information etc.

Traditionally such displays are protected by glass plates on the user side. Although the use of glass results in adequate protection of the display, glass is disadvantageous with respect to its weight, its inherent sensitivity (breakage) and its limited capacity for shaping.

With a view to reducing the weight, composite panes have already been developed, particularly in the field of vehicle panes, that consist of several individual panes, whereby, with approximately equal thickness of the panes, some of the glass has been replaced by panes made of thermoplastic synthetic material. Thus, for example, a composite pane consisting of the laminated materials polycarbonate and glass has been known for a long time from DE-OS 15 94 164. In this case a primary pane made of high-molecular thermoplastic polycarbonate is surrounded by two outer panes of glass, the panes being connected by means of a layer of thermoplastic polyurethane. From U.S. Pat. No. 5,482,896 a protective layer for LED displays is known wherein an ultra-thin transparent substrate is laminated onto the LED array, use preferably being made of glass byway of ultra-thin substrate in order to protect the actual LED array.

Furthermore, from GB 2 335 884 A a flexible substrate is known which consists of a uniform connection of display and protective layer. Also in this case the structure of the protective layer consists of a combination of a glass layer and a plastic layer.

The object underlying the invention is to specify a composite pane for use as protection of displays, in particular of plasma displays, that is capable of being employed in versatile manner when detached from the actual display, has a low weight, is shatterproof and permits a high degree of design freedom.

This object is achieved by virtue of a composite pane that comprises substantially three layers, of which the inner pane consists of a thermoplastic synthetic material and the outer panes consist of glass, whereby the individual panes are firmly connected to one another by a film of thermoplastic polyurethane and whereby the glass pane facing the display is provided with an electrical shield.

The composite pane according to the invention can, unlike glass, also be employed for large-area plasma displays, for example for advertising media or large screens for projection purposes. Its use is also particularly suitable for publicly accessible displays such as are to be found, for example, at railway stations, airports or such like. The shatterproof nature of the composite pane according to the invention offers, on the one hand, still better protection against damage to the display which is arranged behind it and which is not in contact with the composite pane; furthermore it also reliably prevents injuries in the event of damage to the composite pane, since the latter retains its supporting composite even in the event of breakage of one or both of the glass panes.

By way of electrical shield, use is preferably made of one or more layers of a so-called TCO (transparent contacting oxide). The coating with indium tin oxide (ITO) has proved particularly worthwhile. With a view to increasing the electrical shielding in the case where use is made of several layers, said layers are connected to one another in electrically conducting manner.

In a further refinement of the invention the ITO layer or layers is/are alternatively provided on the surface of the display-side glass pane facing the display or on the surface of the display-side glass pane facing away from the display. From the point of view of manufacturing technology, the coating on the surface of the display-side glass pane facing the display will be preferred. Use is preferably made of polycarbonate for the inner pane of thermoplastic synthetic material, since polycarbonate is capable of being produced with an extremely high degree of transparency, even in relatively thick panes. This holds true in particular when the polycarbonate has been produced from bisphenol A. Such a polycarbonate is marketed by the applicant under the name Makrolon®.

According to a further teaching of the invention, elements for retention, decoration or such like can be attached by injection moulding onto the front faces of the inner pane of thermoplastic synthetic material. In this way it is possible to form, for example, the retaining components for securing the entire composite pane in one piece with the inner pane of thermoplastic synthetic material, so that additional holding elements such as are required in connection with glass panes can be dispensed with completely. It is moreover conceivable for the outer glass panes to be surrounded in the edge region by plastic elements, so that there are no limits to the fashioning of the composite panes according to the invention in terms of design.

A further teaching of the invention provides that the inner pane of thermoplastic synthetic material has a thickness from 0.1 mm to 20 mm, preferably from 2 mm to 6 mm. Composite panes with this thickness can be produced without difficulty also for the use of large-area displays. In comparison with pure glass panes, it is possible for the weight of the pane to be reduced by ¼ to ⅓.

With a view to obtaining complete freedom from distortion it is expedient that the two outer glass panes have the same thickness, so that by reason of the coefficient of expansion which is then the same a high degree of planarity of the composite panes is obtained.

Finally, in a further refinement of the invention there is provision that the glass pane facing the observer has a surface that is scratch-resistant and provided with an antireflective coating. Suitable for this purpose are, in particular, alternating coatings consisting of TiO₂/SiO₂.

In the drawings, which represent merely preferred embodiment examples, possible layer sequences which are laminated with one another are elucidated in more detail.

Shown in the drawings are:

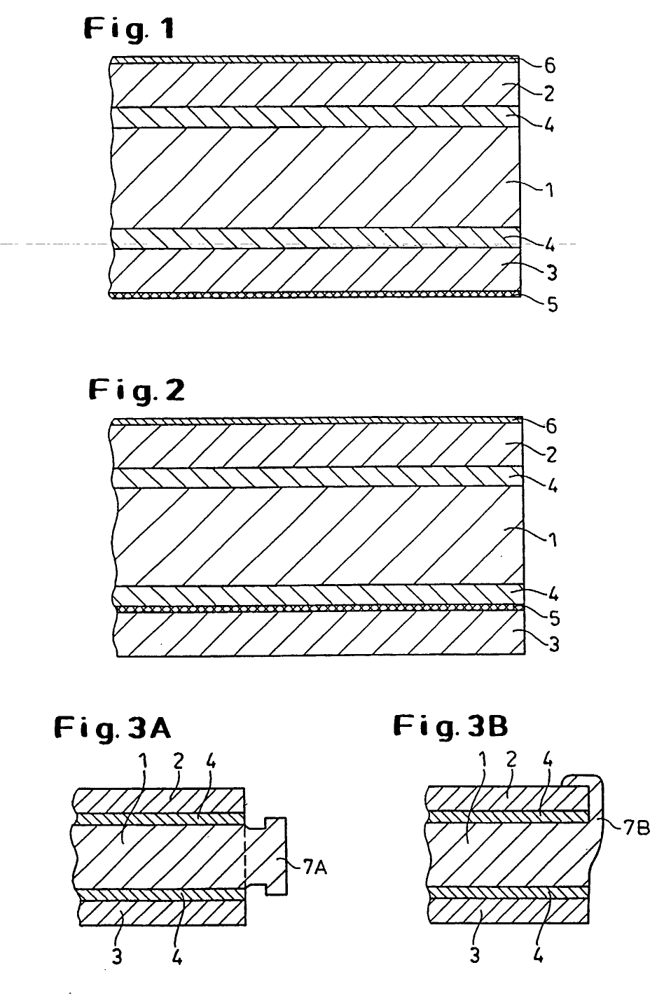

FIG. 1 a layer sequence of a first composite pane according to the invention,

FIG. 2 a layer sequence of another composite pane according to the invention and

FIGS. 3A and 3B possible configurations of the edge region of the aforementioned composite panes.

In FIGS. 1 and 2 two possible layer sequences of composite panes according to the invention are represented schematically. Both panes consist of an inner layer 1 made of a thermoplastic synthetic material, preferably polycarbonate, onto which a glass pane 2 facing the observer and a glass pane 3 facing the display are laminated by means of, in each case, a thin film 4 of polyurethane.

On the display side one or more layers 5 of TCO (transparent conducting oxide) which preferably consists of indium tin oxide (ITO) serves for electrical shielding. In the embodiment example according to FIG. 1 the TCO layer 5 is arranged on the outer surface of the composite pane, and in the embodiment example according to FIG. 2 it is arranged between the outer, display-side glass pane 3 and the PU layer 4 connecting the inner pane 1 and the outer glass pane 3.

FIGS. 3A and 3B show possible configurations of the edge region of the composite panes according to the invention, whereby in FIG. 3A retaining elements 7A are indicated which can be injection-moulded directly onto the inner pane 1, so that separate holding or securing means can be dispensed with. FIG. 3B shows a possible edge shape 7B which is chosen in such a way that it partially encompasses the glass pane 2 facing the observer and so is able to serve as a constituent of the casing for the associated display.

1. A composite pane for use as protection of displays, in particular of plasma displays, said composite pane comprising substantially three panes, of which the inner pane (1) consists of a thermoplastic synthetic material and the outer panes (2, 3) consist of glass, whereby the individual panes (1, 2, 3) are firmly connected to one another by a film (4) of thermoplastic polyurethane and whereby the glass pane (3) facing the display is provided with an electrical shield.

2. Composite pane according to claim 1, characterised in that one or more layers (5) of TCO (transparent conducting oxide) are used by way of electrical shield.

3. Composite pane according to claim 2, characterised in that indium tin oxide is used by way of TCO layers (5).

4. Composite pane according to one of claims 2 or 3, characterised in that the TCO layer (5) is provided on the surface of the glass pane (3) facing the display.

5. Composite pane according to one of claims 2 or 3, characterised in that the TCO layer (5) is provided on the surface of the glass pane (3) facing away from the display.

6. Composite pane according to one of claims 1 to 5, characterised in that polycarbonate is used by way of thermoplastic synthetic material for the inner pane (1).

7. Composite pane according to claim 6, characterised in that the polycarbonate is produced from bisphenol A.

8. Composite pane according to one of claims 1 to 7, characterised in that elements (7A, 7B) for retention, decoration or such like are injection-moulded onto the front faces of the inner pane (1) of thermoplastic synthetic material.

9. Composite pane according to one of claims 1 to 8, characterised in that the inner pane (1) of thermoplastic synthetic material has a thickness from 0.1 mm to 20 mm, preferably from 2 mm to 6 mm.

10. Composite pane according to one of claims 1 to 9, characterised in that the two outer glass panes (2, 3) have the same thickness.

11. Composite pane according to one of claims 1 to 10, characterised in that the glass pane (2) facing the observer has a scratch-resistant surface.

12. Composite pane according to one of claims 1 to 11, characterised in that the glass pane (2) facing the observer is provided with an antireflective coating (6).
